(19) United States
(12) Patent Application Publication
(10) Pub. No.: US 2010/0034169 A1
(43) Pub. Date: Feb. 11, 2010

(54) PACKET DATA CONVERGENCE PROTOCAL END OF HANDOVER INDICATION

(75) Inventors: Shailesh Maheshwari, San Diego, CA (US); Arnaud Meylan, Bois-Colombes (FR); Vanitha A. Kumar, San Diego, CA (US); Peter A. Barany, San Diego, CA (US); Sai Yiu Duncan Ho, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/512,000

(22) Filed: Jul. 29, 2009

Related U.S. Application Data
(60) Provisional application No. 61/086,082, filed on Aug. 4, 2008.
(60) Provisional application No. 61/088,317, filed on Aug. 12, 2008.

(51) Int. Cl. H04W 36/00; H04W 36/16

(52) U.S. Cl. 370/331; 455/436; 370/350

(57) ABSTRACT

Explicit signaling of End of Handover (EoH) advantageously indicates when user equipment (UE) has stopped using Packet Data Convergence Protocol (PDCP) handover mode. Radio Link Control (RLC) Acknowledge Mode (AM) delivers in order ensuring that all reordered packets have been received with no risk of delivering a gap packet when no longer in handover mode that would otherwise cause Hyper Frame Number (HFN) to be out of synchronization. Substantially at a time evolved Base Node (eNB) determines a gap will not be filled, eNB can convey an EoH indication to a served UE and can then deliver the PDCP Service Data Units (SDUs) with gaps to upper layers without delay.

### CLAIM OF PRIORITY UNDER 35 U.S.C. §119

The present Application for patent claims priority to Provisional Application No. 61/088,317 filed Aug. 12, 2008 and to Provisional Application No. 61/086,082 filed 4 Aug. 2008, both entitled “PACKET DATA CONVERGENCE PROTOCAL END OF HANDOVER INDICATION”, and both assigned to the assignee hereof and hereby expressly incorporated by reference herein.

### BACKGROUND

1. Field

The present disclosure relates generally to communication and more specifically seamless data transfer during handover in a wireless communication network.

2. Background

In packet-based advanced wireless telecommunication, during handover, within the User Equipment (UE), Uplink (UL) Radio Link Control (RLC) passes the received RLC Service data units (SDUs) possibly with gaps to Packet Data Convergence Protocol (PDCP), which operates in “handover mode,” or PDCP reordering mode, to provide Downlink (DL) lossless data transfer, re-ordering, and duplicate elimination for a time span defined by a flush timer. At least one objective of the flush timer is to ensure delivery of DL data not in sequence, should a missing DL PDCP Protocol Data Unit (PDU) not be received.

Various aspects of communication are sensitive to the flush timer and its utilization as an indicator to stop PDCP handover mode, and can be detrimental to communication. Accordingly, it is substantially relevant for robust communication that a target Evolved Universal Mobile Telecommunications System Terrestrial Radio Access Network (E-UTRAN) base node (eNB) has a reliable estimate of when the flush timer is to expire in the UE.

### SUMMARY

The following presents a simplified summary in order to provide a basic understanding of some aspects of the disclosed aspects. This summary is not an extensive overview and is intended to neither identify key or critical elements nor delineate the scope of such aspects. Its purpose is to present some concepts of the described features in a simplified form as a prelude to the more detailed description that is presented later.

In one aspect, a method is provided for seamless data transfer during handover with robustness and low latency, by employing a processor executing computer executable instructions stored on a computer readable storage medium to implement following acts: A handover command is received at the UE from a source node to perform a handover procedure with a target node. When an End of Handover (EOH) indication is received by the UE from the target node, an in-order delivery and duplicate elimination function in a Packet Data Convergence Protocol (PDCP) layer is terminated.

In another aspect, a computer program product is provided for seamless data transfer during handover with robustness and low latency. At least one computer readable storage medium stores computer executable instructions that, when executed by at least one processor, implement components. A first set of codes receives a handover command from a source node to perform a handover procedure with a target node. A second set of codes receives End of Handover (EOH) indication from the target node. A third set of codes terminates an in-order delivery and duplicate elimination function in a Packet Data Convergence Protocol (PDCP) layer.

In additional aspect, an apparatus is provided for seamless data transfer during handover with robustness and low latency. At least one computer readable storage medium stores computer executable instructions that, when executed by the at least one processor, implement components: Means are provided for receiving a handover command from a source node to perform a handover procedure with a target node. Means are provided for receiving End of Handover (EOH) indication from the target node. Means are provided for terminating an in-order delivery and duplicate elimination function in a Packet Data Convergence Protocol (PDCP) layer.

In a further aspect, an apparatus is provided for seamless data transfer during handover with robustness and low latency. A receiver receives a handover command from a source node to perform a handover procedure with a target node. The receiver receives End of Handover (EOH) indication from the target node. A computing platform terminates an in-order delivery and duplicate elimination function in a Packet Data Convergence Protocol (PDCP) layer.

In yet one aspect, a method is provided for seamless data transfer during handover with robustness and low latency by employing a processor executing computer executable instructions stored on a computer readable storage medium to implement following acts: A handover command is transmitted to user equipment from a source node to perform a handover procedure with a target node. The handover procedure is determined not to be needed any longer. An End of Handover (EOH) indication is transmitted to the user equipment.

In yet another aspect, a computer program product is provided for seamless data transfer during handover with robustness and low latency. At least one computer readable storage medium stores computer executable instructions that, when executed by at least one processor, implement components: A first set of codes transmits a handover command to user equipment from a source node to perform a handover procedure with a target node. A second set of codes determines that the handover procedure is no longer needed. A third set of codes transmits End of Handover (EOH) indication to the user equipment.

In yet an additional aspect, an apparatus is provided for seamless data transfer during handover with robustness and low latency. At least one computer readable storage medium stores computer executable instructions that, when executed by the at least one processor, implement components: Means are provided for transmitting a handover command to user equipment from a source node to perform a handover procedure with a target node. Means are provided for determining that the handover procedure is no longer needed. Means are provided for transmitting End of Handover (EOH) indication to the user equipment.

In yet a further aspect, an apparatus is provided for seamless data transfer during handover with robustness and low latency. A transmitter transmits a handover command to user equipment from a source node to perform a handover procedure with a target node. A computing platform determines that the handover procedure is no longer needed. The transmitter further transmits End of Handover (EOH) indication to the user equipment.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a block diagram of a wireless communication system with end of handover indication for robust and efficient Packet Data Conversion Protocol (PDCP) handover mode of operation.

FIG. 2 illustrates a timing diagram of a methodology for robust and efficient Packet Data Conversion Protocol (PDCP) handover mode of operation.

FIG. 3 illustrates a multiple access wireless communication system according to one embodiment.

FIG. 4 is a block diagram of a communication system.

FIG. 5 illustrates a block diagram of a protocol stack that facilitates operation of user equipment and an evolved Base Node (eNB) in accordance with aspects described herein.

FIG. 6 illustrates an example format of a PDCP control PDU to signal end of PDCP handover mode of operation.

FIG. 7 depicts a block diagram of user equipment having a logical grouping of electrical components for seamless data transfer during handover with robustness and low latency.

FIG. 8 depicts a block diagram of a base node having a logical grouping of electrical components for seamless data transfer during handover with robustness and low latency.

FIG. 9 depicts a block diagram of an apparatus having means for seamless data transfer during handover with robustness and low latency.

FIG. 10 depicts a block diagram of an apparatus having means for seamless data transfer during handover with robustness and low latency.

### DETAILED DESCRIPTION

Explicit signaling of End of Handover (EoH) advantageously indicates when user equipment (UE) has stopped using Packet Data Convergence Protocol (PDCP) handover mode. Thereby, use of a flush timer by User Equipment (UE) to get out of PDCP handover mode is avoided.

In particular, the following aspects of utilization of flush timer to sustain and terminate handover can be noted that are not robust and are not efficient:

(i) When a gap in the sequence of received DL PDCP Service Data Unit (SDU) remains, the SDUs after the gap are passed to upper layer only when the flush timer expires. Therefore large values of the flush timer may delay data on Radio Link Control (RLC) Acknowledged Mode (AM) bearers when some gaps in the sequence of PDCP SDUs cannot be filled (e.g., forwarding failed, or one packet was dropped due to Active Queue Management (AQM)).

(ii) If a flush timer expires while retransmissions of DL PDCP SDU with SN (sequence number)<Next_PDCP_RX_SN are still occurring, indicating PDCP will operate in non-handover mode, the Hyper Frame Number (HFN) will get out of synchronization and a call (voice or data) can be dropped. Therefore, it is substantially important for a target eNB to know whether the flush timer in the UE is still running or it has elapsed.

(iii) Once a DL PDCP PDU is submitted to RLC AM for transmission at the eNB, the RLC protocol does not allow to control when the corresponding RLC SDU will be delivered at the receiver. Due to substantive Automatic Repeat request (ARQ), it is possible that a PDCP SDU submitted while flush timer still had a substantive time before elapsing would be delivered to the receiver after flush timer expiration.

(iv) In view that there is no RLC move receiver window mechanism, the eNB cannot do anything else but re-establish RLC if that is about to occur in order to avoid getting the receiver out of HFN synchronization.

(v) In conventional packet-based telecommunication systems, PDCP is informed of a handover when a handover command is received, and that in turn starts the PDCP flush timer. Then a UE that is handed over must acquire the target cell and proceed with Random Access Channel (RACH) procedure in order to successfully complete the handover. Subsequently, a target eNB has an unknown amount of time, upper bounded by the flush timer, to complete the retransmission of DL PDCP SDUs. In order to cope with such uncertainty the flush timer is likely to be configured to large values (e.g., 1 second), which typically increase latency at handover and can delay user traffic is as much as the set value for the flush timer.

Communication aspects (i)-(v) affected by flush timer show example risks and inefficiencies associated with using a flush timer to terminate PDCP handover mode.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

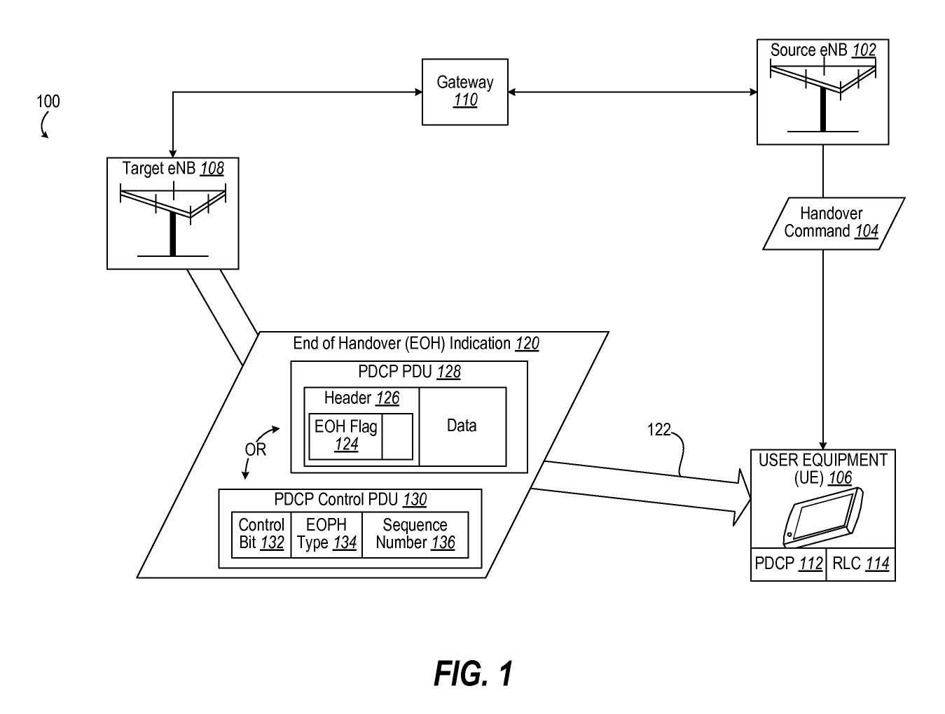

In FIG. 1, a wireless communication system 100 provides a substantially more robust communication with low latency when a source base node, depicted as an evolved Base Node (eNB) 102 instructs, as depicted at 104, user equipment (UE) 106 to perform a handover to a target eNB 108 as coordinated by gateway 110. The UE 106 passes the received Radio Link Control (RLC) Service Data Units (SDUs) to an upper layer such as Packet Data Convergence Protocol (PDCP) 112 from a lower layer such as RLC 114 for re-ordering and eliminating duplicates.

The target eNB 108 can perform decoding a plurality of PDCP PDUs 116 that were re-ordered with duplicates eliminated by the UE 106. The target eNB 108 can utilize an explicit “End of Handover” (EOH) indication 120 on downlink 122 to instruct the UE 106 to stop employing Packet Data Convergence Protocol (PDCP) in handover mode. In an exemplary aspect, EOH indication 120 can be accomplished through utilization of one or more reserved bits (e.g., setting an “EOH Flag”) 124 in a PDCP header 126 of a PDCP PDU 128 for detecting by the UE 106. Alternatively, the eNB can generate and convey a PDCP control Protocol Data Unit (PDU) 130 comprised of a data/control bit 132 set to control, a PDCP type segment 134 indicating EOH type, followed by a sequence number 136. It is to be appreciated that use of a PDCP control PDU 130 can provide a versatile, clean design. When the UE 106 receives the EOH indication 120, the UE 106 can deactivate in-order delivery and duplicate elimination function in the downlink (DL) if such features are activated.

In addition, the subject innovation can also determine a beginning of PDCP handover mode of operation in addition by signaling a beginning of PDCP handover mode of operation. It is to be noted that signaling 120 of beginning of PDCP handover mode of operation can differ from at least one of determining EOPH mode of operation or signaling EOPH mode of operation as discussed above.

Such explicit PDCP EOH indication 120 provides at least the following advantages to communication.

(i) Communication Robustness. Since RLC AM delivers in order, the eNB 102 can be sure that the PDCP in the UE 104 will not stop using the handover mode before all the to-be-reordered packets have been received. Therefore there is no risk of delivering a “gap” packet when PDCP is no longer in handover mode, which would get Hyper Frame Number (HFN) out of synchronization. In addition, there is no need to set a value of flush time that works for handover as well as Radio Resource Control (RRC) connection re-establishment.

(ii) Simplicity. There is no need to use RRC to configure a flush timer (on a per handover basis) to indicate termination, upon expiration of the flush timer, of PDCP handover mode of operation.

(iii) Low latency. Substantially at a time eNB 102 determines a gap will not be filled, eNB 102 can convey an EOH indication to a served UE 104, which can then deliver the PDCP SDUs with gaps to upper layers without delay.

It should be appreciated that the subject innovation can mitigate telecommunication performance issues associated with the existence of a single flush timer that is employed for both handover and RRC connection re-establishment. In handover, in view of aspects of the attachment procedure, target eNB knows when UE will attach to the cell and thus access can be made reliable. Conversely, RRC connection re-establishment is substantially more uncertain as to when it can occur between initiation of re-establishment and completion of reconfiguration. Therefore, to be prepared for a worst-case scenario, when a flush timer is triggered at the same time a handover indication is conveyed, the flush timer is typically conservative enough to avoid desynchronization, which can result in a flush timer value that is pessimistic for the handover operation.

It should be appreciated that when a UE already operates in non-handover-mode state, the UE can disregard received EOH indication, which can be an EOH indication within a PDCP header or via a PDCP control PDU, as indicated above. In case EOH indication is conveyed within a PDCP header (e.g., via a set of reserved (R) bits), the UE will process PDUs and disregard EOH indication.

Back-to-back handovers. In case of back-to-back handovers, after the second handover is indicated to PDCP by RRC, it is possible that an EOH indication associated with the first handover is delivered by RLC as it is re-established; it should be appreciated that RRC communication re-establishment includes PDCP operation in handover mode. Such EOH indication should be disregarded by the PDCP. To ensure the latter, EOH signaling packets that are received due to RLC re-establishment are ignored by PDCP. Ignoring the EOH indication in this instance avoids an inappropriate termination of the handover procedure.

In one aspect of the subject innovation, when one or more reserved bits in PDCP header are used for EOH indication, it is considered that a target eNB substantially in all instances adds/updates the one or more reserved (R) bits. (It is to be noted that “update” is necessary for a case when source eNB forwards complete PDCP packets, e.g., <PDCP header+payload> to a target eNB. Such addition/update allows eNB to put a UE in handover mode in a substantially arbitrary manner.

In the subject innovation, in addition or as an alternative to utilization of one or more reserved bits for EOH signaling, a window concept to PDCP can be introduced, wherein PDCP discards PDUs that are received out of window, in substantially the same manner as in RLC. Such window utilization can lead to communication under handover mode substantially all the time.

Case of duplicates. In the subject innovation, when EOH is transported by one or more reserved bits in PDCP PDU header, it can occur that the PDU corresponds to an already received SDU (e.g., a duplicate). In such an instance, in an aspect of the subject innovation, duplicate elimination function can consider the EOH indication before discarding the duplicate. Such elimination is similar to Robust Header Compression (RoHC) decompression, which for duplicates is performed before the duplicates are eliminated. In duplicates case, the UE can perform deciphering, decompressing, processing EOH indication and then discarding such packet.

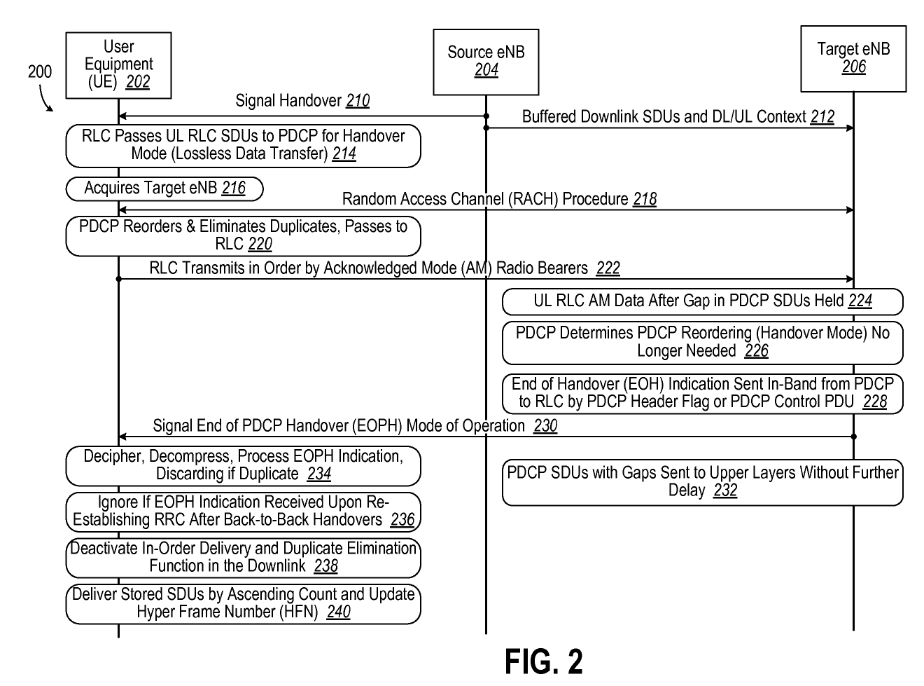

In FIG. 2, a methodology or sequence of operations 200 is depicted for a UE 202 to be handed over from a source eNB 204 to a target eNB 206 with seamless data transfer in a robust fashion with low latency. The source eNB 204 transmits a handover command to the UE 202 to perform handover procedure from the source eNB 204 to the target eNB 206 as depicted at 210. The source eNB 204 transmits buffered downlink Service Data Units (SDUs) and downlink and uplink context to the target eNB 206 as depicted at 212.

The UE 202 responds to the handover command by having its Radio Link Control (RLC) pass uplink RLC SDUs to an upper layer of the PDCP for performing handover mode to achieve lossless data transfer (block 214). The UE 202 acquires the target eNB 206 (block 216) and then performs Random Access Channel (RACH) procedure with the target eNB 206 (block 218). The UE 202 can perform acquiring of the target eNB 206 based upon parameters learned during measurement gaps, relayed by the source eNB 204, etc. The UE 202 performs PDCP re-ordering and eliminating of duplicating, passing the resulting PDUs to RLC (block 220). The target eNB transmits the PDCP PDUs in order by RLC Acknowledge Mode (AM) radio bearers to the UE 202 as depicted at 222.

At some point, PDCP layer determines that PDCP re-ordering (i.e., handover mode) is no longer needed (block 226). In an exemplary aspect, response, the target eNB 206 generates an End of Handover (EOH) indication sent in-band from PDCP to RLC by PDCP header flag or PDCP control PDU (block 228) and transmitted to the UE 202 as depicted at 230. In the illustrative implementation, the EOH can be referred to as an End of PDCP Handover (EOPH) mode of operation indication. The target eNB 206 can deliver PDCP SDUs with gaps without further delay to upper layers (block 232).

The UE 202 can decipher, decompress, and process an EOH or EOPH indication, discarding if a duplicate (block 234). The UE 202 ignores an EOPH indication if received upon re-establishing Radio Resource Control (RRC) after back-to-back handovers (block 236). The UE 202 deactivates in-order delivery and duplicate elimination function in the downlink (block 238). The UE 202 delivers stored SDUs to upper layers by ascending count and updates Hyper Frame Number (HFN) for synchronization purposes (block 240).

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

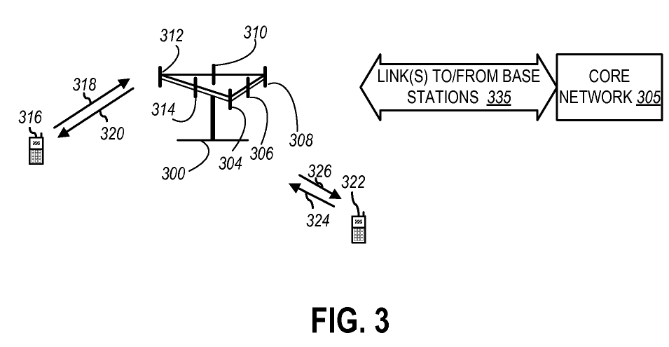

Referring to FIG. 3, a multiple access wireless communication system according to one embodiment is illustrated. An access point 300 (AP) includes multiple antenna groups, one including 304 and 306, another including 308 and 310, and an additional including 312 and 314. In FIG. 3, only two antennas are shown for each antenna group, however, more or fewer antennas may be utilized for each antenna group. Access terminal 316 (AT) is in communication with antennas 312 and 314, where antennas 312 and 314 transmit information to access terminal 316 over forward link 320 and receive information from access terminal 316 over reverse link 318. Access terminal 322 is in communication with antennas 306 and 308, where antennas 306 and 308 transmit information to access terminal 322 over forward link 326 and receive information from access terminal 322 over reverse link 324. In a FDD system, communication links 318, 320, 324 and 326 may use different frequency for communication. For example, forward link 320 may use a different frequency then that used by reverse link 318.

Each group of antennas and/or the area in which they are designed to communicate is often referred to as a sector of the access point. In the aspect, antenna groups each are designed to communicate to access terminals in a sector, of the areas covered by access point 300. Areas covered by AP 300 are conventionally known as macro cell(s).

Additionally, within coverage area of AP 300, a plurality of disparate access points 340 can provided localized coverage (e.g., in a femto cell or pico cell). Access terminals served by AP 300 can communicate with APs 340; for example, AT 316 can communicate with one of AP 340 via a reverse link 334 and a forward link 336. In an aspect, communication between AT 316 and AP 340 can proceed in accordance with substantially the same telecommunication protocol(s)/standard(s) as those for communication in the macro cell between AT 316 and AP 300.

In communication over forward links 320 and 326, the transmitting antennas of access point 300 utilize beamforming in order to improve the signal-to-noise ratio of forward links for the different access terminals 316 and 324. In addition, an access point using beamforming to transmit to access terminals scattered randomly through its coverage causes less interference to access terminals in neighboring cells than an access point transmitting through a single antenna to all its access terminals.

In addition, FIG. 3 illustrates a core network 305 that communicates with base station 300 through link(s) 335; it should be appreciated that core network 305 also communicates with other based stations (not shown). Link(s) 335 can be wired (e.g., an optical fiber, a digital subscriber line, a twisted-pair cable, a coaxial cable . . . ) or wireless. Core network 305 typically comprises substantially any component that generates and/or administers (e.g., schedules, retains communication records, policies . . . ) packetized communications (e.g., communications based on internet protocol (IP) packets) such as data flows for UEs 316 or 322. Core network 305 generally includes a serving gateway (SGW; not shown) that conveys data, or traffic, to a serving base station(s) (e.g., access point 300), and receive data from the base station(s) as well. Additionally, core network 305 can include a mobility management entity (MME; not shown) which administers control information to base stations operated by the core network 305.

An access point may be a fixed station used for communicating with the terminals and may also be referred to as an access point, a Node B, an evolved Base Node (eNB), a home eNB, or some other terminology. An access terminal may also be called an access terminal, user equipment (UE), a wireless communication device, terminal, access terminal or some other terminology.

A MIMO system employs multiple (N_{T}) transmit antennas and multiple (N_{R}) receive antennas for data transmission. A MIMO channel formed by the N_{T} transmit and N_{R} receive antennas may be decomposed into Ns independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

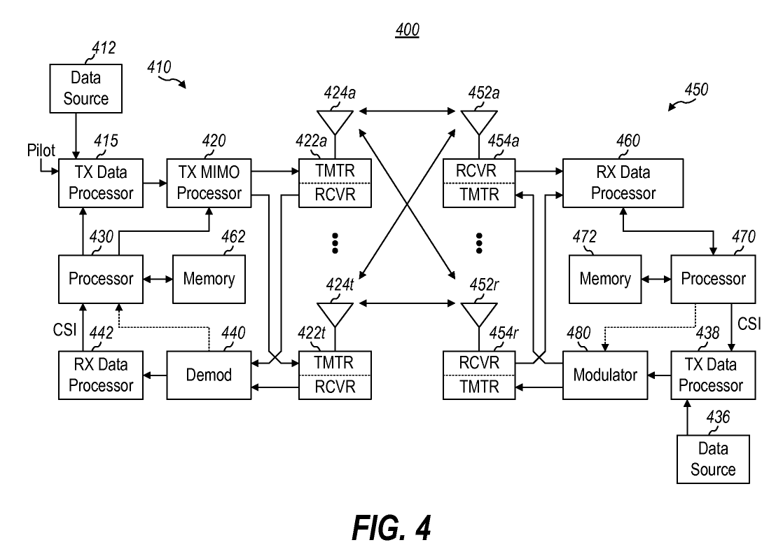

FIG. 4 is a block diagram of a version of a transmitter system 410 (also known as the access point) and a receiver system 450 (also known as access terminal) in a MIMO system 400. At the transmitter system 410, traffic data for a number of data streams is provided from a data source 412 to a transmit (TX) data processor 414.

In an aspect, each data stream is transmitted over a respective transmit antenna. TX data processor 414 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 430.

The modulation symbols for all data streams are then provided to a TX MIMO processor 420, which may further process the modulation symbols (e.g., for OFDM). TX MIMO processor 420 then provides NT modulation symbol streams to NT transmitters (TMTR) 422a through 422t. In certain embodiments, TX MIMO processor 420 applies beamforming weights to the symbols of the data streams and to the antenna from which the symbol is being transmitted.

Each transmitter 422 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 422a through 422t are then transmitted from NT antennas 424a through 424t, respectively.

At receiver system 450, the transmitted modulated signals are received by NR antennas 452a through 452r and the received signal from each antenna 452 is provided to a respective receiver (RCVR) 454a through 454r. Each receiver 454 conditions (e.g., filters, amplifies, and downconverts) a respective received signal, digitizes the conditioned signal to provide samples, and further processes the samples to provide a corresponding “received” symbol stream.

An RX data processor 460 then receives and processes the NR received symbol streams from NR receivers 454 based on a particular receiver processing technique to provide NT “detected” symbol streams. The RX data processor 460 then demodulates, deinterleaves, and decodes each detected symbol stream to recover the traffic data for the data stream. The processing by RX data processor 460 is complementary to that performed by TX MIMO processor 420 and TX data processor 414 at transmitter system 410.

A processor 470 periodically determines which pre-coding matrix to use (discussed below). Processor 470 formulates a reverse link message comprising a matrix index portion and a rank value portion.

The reverse link message may comprise various types of information regarding the communication link and/or the received data stream. The reverse link message is then processed by a TX data processor 438, which also receives traffic data for a number of data streams from a data source 436, modulated by a modulator 480, conditioned by transmitters 454a through 454r, and transmitted back to transmitter system 410.

At transmitter system 410, the modulated signals from receiver system 450 are received by antennas 424, conditioned by receivers 422, demodulated by a demodulator 440, and processed by a RX data processor 442 to extract the reserve link message transmitted by the receiver system 450. Processor 430 then determines which pre-coding matrix to use for determining the beamforming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In aspect, Logical Traffic Channels comprises a Dedicated Traffic Channel (DTCH) which is point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), an Uplink Shared Data Channel (UL-SDCH) and a plurality of PHY channels. The PHY channels comprise a set of DL channels and UL channels.

The DL PHY channels can comprise Common Pilot Channel (CPICH), Synchronization Channel (SCH), Common Control Channel (CCCH), Shared DL Control Channel (SDCCH), Multicast Control Channel (MCCH), Shared UL Assignment Channel (SUACH), Acknowledgement Channel (ACKCH), DL Physical Shared Data Channel (DL-PSDCH), UL Power Control Channel (UPCCH), Paging Indicator Channel (PICH), and Load Indicator Channel (LICH).

The UL PHY Channels can comprise Physical Random Access Channel (PRACH), Channel Quality Indicator Channel (CQICH), Acknowledgement Channel (ACKCH), Antenna Subset Indicator Channel (ASICH), Shared Request Channel (SREQCH), UL Physical Shared Data Channel (UL-PSDCH), and Broadband Pilot Channel (BPICH).

In an aspect, a channel structure is provided that preserves low PAR (at any given time, the channel is contiguous or uniformly spaced in frequency) properties of a single carrier waveform.

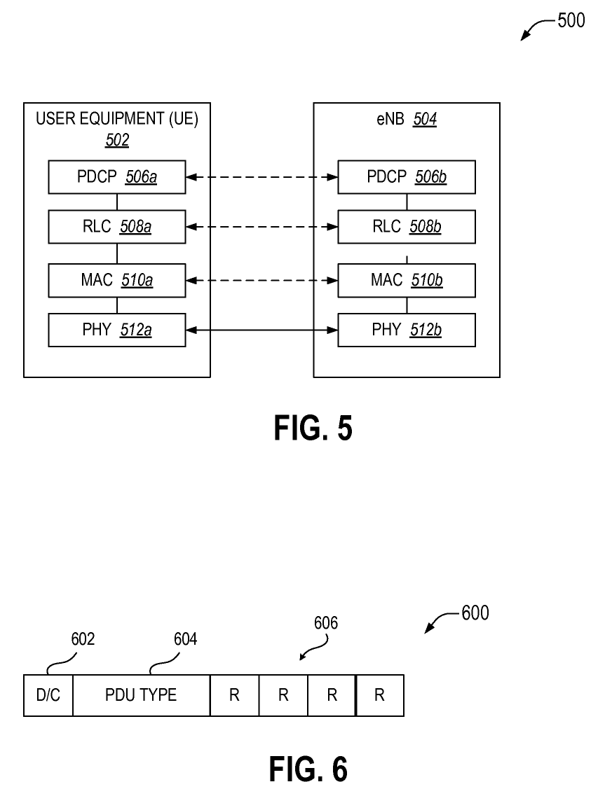

FIG. 5 illustrates a block diagram 500 of a protocol stack 501 that facilitates operation of user equipment (UE) 502 and an eNB (e.g., a target eNB or a serving eNB) 504 in accordance with aspects described herein. In particular, the protocol stack 501 comprises upper layers to lower layers depicted as Packet Data Convergence Protocol (PDCP) layer 506a, Radio Link Control (RLC) layer 508a, Medium Access Control (MAC) layer 510a and Physical (PHY) layer 512a of the UE 502. This corresponds to the protocol stack 501 comprising upper layers to lower layers depicted as PDCP layer 506b, RLC layer 508b, MAC layer 510b and PHY layer 512b of the eNB 504. Upper layers transmit Service Data Units (SDUs) to lower data units that create Protocol Data Units (PDUs) for transmission. The wireless transmission is between PHY layers 512a, 512b, which can be a downlink from eNB 504 to UE 502 or an uplink from UE 502 to eNB 504. Each pair of layers 506a-506b, 508a-508b, 510a-510b is capable of decoding on a receive side what was encoded respectively on a transmit side.

It is noted that processor(s) (not shown), which can reside in UE 502 and eNB 504, can provide at least in part the functionality of associated with explicit signaling described in the subject disclosure. Memory component(s) (not shown), which can reside in UE 502 and eNB 504, can store data structures, code instructions, and substantially any information necessary for eNB 504 and UE 502 to communicate and receive, respectively, EOH signaling in accordance with aspects described herein. It should be appreciated that the aforementioned processor(s) can exploit information (e.g., methods or algorithms) in memory to provide, at least in part, UE and eNB their respective functionality.

FIG. 6 illustrates for PDCP control PDU 600 to signal end of PDCP handover (EOPH) mode of operation. A Data/Control (D/C) bit 602 is set to indicate control rather than data. As an example, PDU Type 604 can indicate end of PDCP handover via a three-bit combination “010.” It should be appreciated that other combination(s) or number of bits can be employed to convey the indication of PDCP end of handover. In addition, other formats for PDCP control PDU can be utilized. A plurality of bits thereafter, depicted as four “R” bits 606, can provide a sequence number (SN).

By virtue of the foregoing, in one aspect an apparatus operable in a wireless communication system is provided. Means are provided for determining end of packet data convergence protocol (PDCP) handover mode of operation. Means are provided for signaling end of PDCP handover (EOPH) mode of operation, wherein signaling EOPH includes a PDCP control PDU. In another aspect, the signaling EOPH further includes one or more reserved bits in a PDCP header. In particular, the EOPH signaling can be delivered in-band in conjunction with disparate PDCP PDUs to a lower protocol layer. In a specific aspect, a PDCP lower protocol layer facilitates ordered service data unit (SDU) delivery. For example, means are provided means for determining beginning of PDCP handover mode of operation and means are provided for signaling beginning of handover mode of operation, wherein the signaling means differs from at least one of the means for determining EOPH mode of operation or the means for signaling EOPH mode of operation. Such aspects can be incorporated at least in part in user equipment or target eNB.

In another aspect, a method used in a wireless communication system is provided by determining end of packet data convergence protocol (PDCP) handover mode of operation and signaling end of PDCP handover (EOPH) mode of operation, wherein signaling EOPH includes a PDCP control PDU. In particular, the method can further entail determining beginning of PDCP handover mode of operation and signaling beginning of handover mode of operation. In a specific example, signaling EOPH further can include one or more reserved bits in a PDCP header. These aspects can be executed by an electronic device such as user equipment or target eNB. Further, these aspects can be instructions stored on computer readable storage medium and executed by a processor. In a further aspect, these aspects can be performed by an apparatus that contains memory having such instructions stored and executed by a processor.

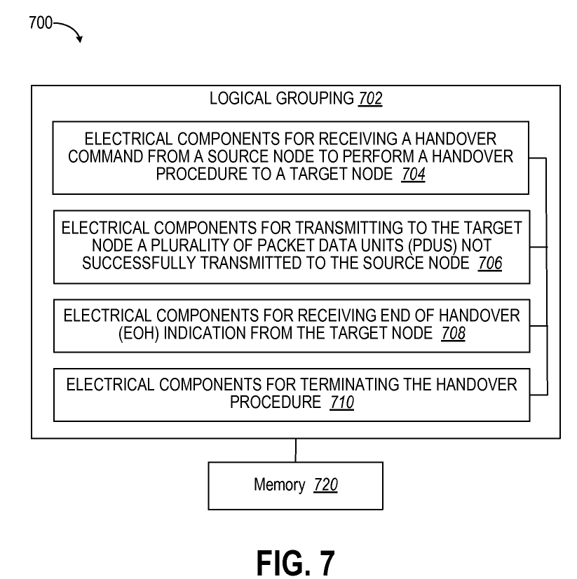

With reference to FIG. 7, illustrated is a system 700 for seamless data transfer during handover with robustness and low latency. For example, system 700 can reside at least partially within user equipment (UE). It is to be appreciated that system 700 is represented as including functional blocks, which can be functional blocks that represent functions implemented by a computing platform, processor, software, or combination thereof (e.g., firmware). System 700 includes a logical grouping 702 of electrical components that can act in conjunction. For instance, logical grouping 702 can include an electrical component for receiving a handover command from a source node to perform a handover procedure with a target node 704. Moreover, logical grouping 702 can include an electrical component for transmitting to the target node a plurality of Packet Data Units (PDUs) not successfully transmitted to the source node 706. In addition, logical grouping 702 can include an electrical component for receiving End of Handover (EOH) indication from the target node 708. Logical grouping 702 can include an electrical component for terminating the handover procedure 710. Additionally, system 700 can include a memory 720 that retains instructions for executing functions associated with electrical components 704-710. While shown as being external to memory 720, it is to be understood that one or more of electrical components 704-710 can exist within memory 720.

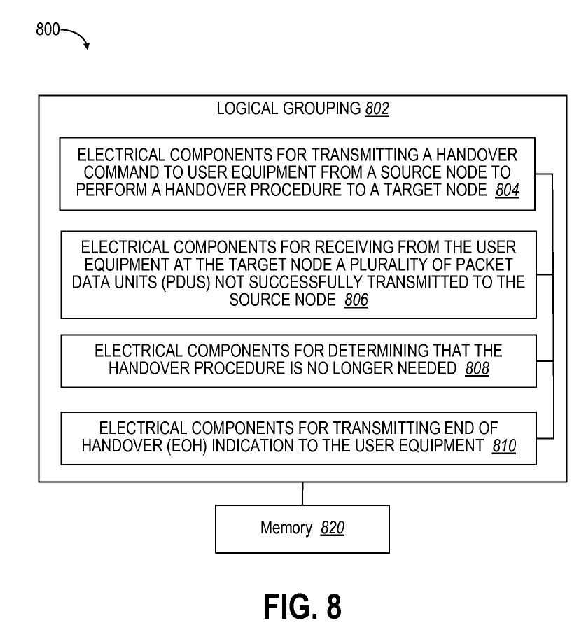

With reference to FIG. 8, illustrated is a system 800 for seamless data transfer during handover with robustness and low latency. For example, system 800 can reside at least partially within a network such as a base node. It is to be appreciated that system 800 is represented as including functional blocks, which can be functional blocks that represent functions implemented by a computing platform, processor, software, or combination thereof (e.g., firmware). System 800 includes a logical grouping 802 of electrical components that can act in conjunction. For instance, logical grouping 802 can include an electrical component for transmitting a handover command to user equipment from a source node to perform a handover procedure with a target node 804. Moreover, logical grouping 802 can include an electrical component for receiving from the user equipment at the target node a plurality of Packet Data Units (PDUs) not successfully transmitted to the source node 806. In addition, logical grouping 802 can include an electrical component for determining that the handover procedure is no longer needed 808. Logical grouping 802 can include an electrical component for transmitting End of Handover (EOH) indication to the user equipment 810. Additionally, system 800 can include a memory 820 that retains instructions for executing functions associated with electrical components 804-810. While shown as being external to memory 820, it is to be understood that one or more of electrical components 804-810 can exist within memory 820.

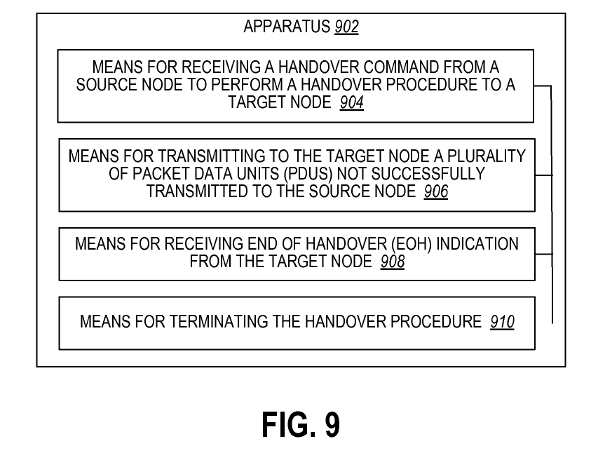

In FIG. 9, an apparatus 902 is depicted for seamless data transfer during handover with robustness and low latency. Means 904 are provided for receiving a handover command from a source node to perform a handover procedure with a target node. Means 906 are provided for transmitting to the target node a plurality of Packet Data Units (PDUs) not successfully transmitted to the source node. Means 908 are provided for receiving End of Handover (EOH) indication from the target node. Means 910 are provided for terminating the handover procedure.

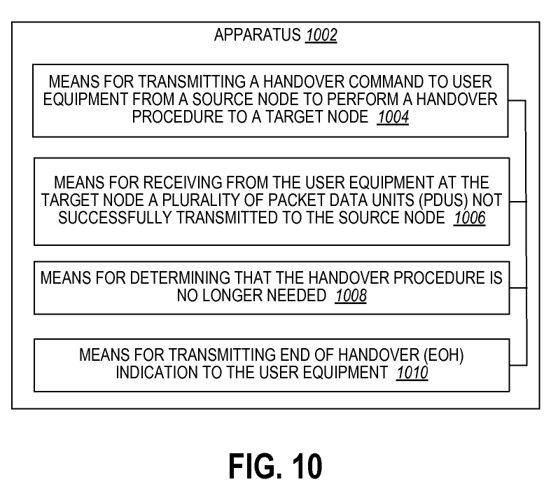

In FIG. 10, an apparatus 1002 is depicted for seamless data transfer during handover with robustness and low latency. Means 1004 are provided for transmitting a handover command to user equipment from a source node to perform a handover procedure with a target node. Means 1006 are provided for receiving from the user equipment at the target node a plurality of Packet Data Units (PDUs) not successfully transmitted to the source node. Means 1008 are provided for determining that the handover procedure is no longer needed. Means 1010 are provided for transmitting End of Handover (EOH) indication to the user equipment.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for seamless data transfer during handover with robustness and low latency, comprising:
employing a processor executing computer executable instructions stored on a computer readable storage medium to implement following acts:
receiving a handover command from a source node to perform a handover procedure with a target node;
receiving an End of Handover (EOH) indication from the target node; and
terminating an in-order delivery and duplicate elimination function in a Packet Data Convergence Protocol (PDCP) layer.

2. The method of claim 1, further comprising performing handover procedure by acquiring the target node and transmitting Random Access Channel (RACH) to the target node.

3. The method of claim 1, further comprising receiving the EOH indication by detecting a bit set in a PDCP header.

4. The method of claim 1, further comprising receiving the EOH indication by receiving a Packet Data Convergence Protocol (PDCP) control Protocol Data Unit (PDU).

5. The method of claim 4, further comprising receiving in-band the PDCP control PDU in conjunction with receiving a plurality of downlink PDCP data PDUs.

6. The method of claim 1, further comprising:
determining occurrence of a second handover;
re-establishing a radio link control;
receiving a second EOH indication on the radio link control that was re-established; and
ignoring the second EOH indication.

7. The method of claim 1, further comprising:
receiving a duplicate EOH indication;
deciphering, decompressing and processing the duplicate EOH indication; and
discarding the duplicate EOH indication.

8. A computer program product for seamless data transfer during handover with robustness and low latency, comprising:
at least one computer readable storage medium storing computer executable instructions that, when executed by at least one processor, implement components comprising:
a first set of codes for receiving a handover command from a source node to perform a handover procedure with a target node;
a second set of codes for receiving an End of Handover (EOH) indication from the target node; and
a third set of codes for terminating an in-order delivery and duplicate elimination function in a Packet Data Convergence Protocol (PDCP) layer.

9. An apparatus for seamless data transfer during handover with robustness and low latency, comprising:
at least one processor;
at least one computer readable storage medium storing computer executable instructions that, when executed by the at least one processor, implement components comprising:
means for receiving a handover command from a source node to perform a handover procedure with a target node;
means for receiving an End of Handover (EOH) indication from the target node; and
means for terminating an in-order delivery and duplicate elimination function in a Packet Data Convergence Protocol (PDCP) layer.

10. An apparatus for seamless data transfer during handover with robustness and low latency, comprising:
a receiver for receiving a handover command from a source node to perform a handover procedure with a target node;
the receiver is further for receiving an End of Handover (EOH) indication from the target node; and
a computing platform for terminating an in-order delivery and duplicate elimination function in a Packet Data Convergence Protocol (PDCP) layer.

11. The apparatus of claim 10, wherein the receiver is further for performing handover procedure by acquiring the target node; and
the transmitter is further for transmitting Random Access Channel (RACH) to the target node.

12. The apparatus of claim 10, wherein the computing platform is further for receiving the EOH indication by detecting a bit set in a PDCP header.

13. The apparatus of claim 10, wherein the computing platform is further for receiving the EOH indication by receiving a Packet Data Convergence Protocol (PDCP) control Protocol Data Unit (PDU).

14. The apparatus of claim 13, wherein the receiver is further for receiving in-band the PDCP control PDU in conjunction with receiving a plurality of downlink PDCP data PDUs.

15. The apparatus of claim 10, wherein the receiver is further for determining occurrence of a second handover;
the receiver and transmitter are further for re-establishing a radio link control;
the receiver is further for receiving a second EOH indication on the radio link control that was re-established; and
the computing platform is further for ignoring the second EOH indication.

16. The apparatus of claim 10, wherein the receiver is further for receiving a duplicate EOH indication; and
the computing platform is further for deciphering, decompressing and processing the duplicate EOH indication, and for discarding the duplicate EOH indication.

17. A method for seamless data transfer during handover with robustness and low latency, comprising:
employing a processor executing computer executable instructions stored on a computer readable storage medium to implement following acts:
transmitting a handover command to user equipment from a source node to perform a handover procedure with a target node;
determining that the handover procedure is no longer needed; and
transmitting an End of Handover (EOH) indication to the user equipment.

18. The method of claim 17, further comprising:
receiving Radio Link Control (RLC) Service Data Units (SDUs) by RLC Acknowledge Mode (AM) radio bearers; and
decoding a plurality of Packet Data Convergence Protocol (PDCP) Protocol Data Units (PDUs) that were re-ordered with duplicates eliminated by the user equipment.

19. The method of claim 18, further comprising:
determining a gap in the PDCP PDUs;
storing PDCP PDUs subject to the gap; and
delivering the PDCP PDUs that were stored to an upper layer in response to transmitting the EOH indication to the user equipment.

20. The method of claim 17, further comprising performing handover procedure receiving Random Access Channel (RACH) from the user equipment.

21. The method of claim 17, further comprising transmitting the EOH indication by setting a bit in a PDCP header.

22. The method of claim 17, further comprising transmitting the EOH indication by transmitting a Packet Data Convergence Protocol (PDCP) control Protocol Data Unit (PDU).

23. The method of claim 22, further comprising delivering in-band the PDCP control PDU in conjunction with delivering a plurality of downlink PDCP data PDUs.

24. A computer program product for seamless data transfer during handover with robustness and low latency, comprising:
at least one computer readable storage medium storing computer executable instructions that, when executed by at least one processor, implement components comprising:
a first set of codes for transmitting a handover command to user equipment from a source node to perform a handover procedure with a target node;
a second set of codes for determining that the handover procedure is no longer needed; and
a third set of codes for transmitting an End of Handover (EOH) indication to the user equipment.

25. An apparatus for seamless data transfer during handover with robustness and low latency, comprising:
at least one processor;
at least one computer readable storage medium storing computer executable instructions that, when executed by the at least one processor, implement components comprising:
means for transmitting a handover command to user equipment from a source node to perform a handover procedure with a target node;
means for determining that the handover procedure is no longer needed; and
means for transmitting an End of Handover (EOH) indication to the user equipment.

26. An apparatus for seamless data transfer during handover with robustness and low latency, comprising:
a transmitter for transmitting a handover command to user equipment from a source node to perform a handover procedure with a target node;
a receiver for receiving from the user equipment at the target node a plurality of Packet Data Units (PDUs) not successfully transmitted to the source node;
a computing platform for determining that the handover procedure is no longer needed; and
the transmitter further for transmitting an End of Handover (EOH) indication to the user equipment.

27. The apparatus of claim 26, wherein the receiver is further for receiving Radio Link Control (RLC) Service Data Units (SDUs) by RLC Acknowledge Mode (AM) radio bearers; and
the computing platform is further for decoding a plurality of Packet Data Convergence Protocol (PDCP) Protocol Data Units (PDUs) that were re-ordered with duplicates eliminated by the user equipment.

28. The apparatus of claim 27, wherein the computing platform is further for determining a gap in the PDCP PDUs, for storing PDCP PDUs subject to the gap, and for delivering the PDCP PDUs that were stored to an upper layer in response to transmitting the EOH indication to the user equipment.

29. The apparatus of claim 26, wherein the receiver is further for performing handover procedure receiving Random Access Channel (RACH) from the user equipment.

30. The apparatus of claim 26, wherein the transmitter is further for transmitting the EOH indication by setting a bit in a PDCP header.

31. The apparatus of claim 26, wherein the transmitter is further for transmitting the EOH indication by transmitting a Packet Data Convergence Protocol (PDCP) control Protocol Data Unit (PDU).

32. The apparatus of claim 31, wherein the computing platform is further for delivering in-band the PDCP control PDU in conjunction with delivering a plurality of downlink PDCP data PDUs.
